(19) United States
(12) Patent Application Publication
(10) Pub. No.: US 2007/0287000 A1
(43) Pub. Date: Dec. 13, 2007

(54) Methods for coating substrates

(76) Inventors: Jennifer L. Thomas, Pittsburgh, PA (US); Anthony M. Chasser, Glenshaw, PA (US); Shengkui Hu, Baden, PA (US); Richard Foukes, Mars, PA (US)

Correspondence Address: PPG INDUSTRIES, INC.;Intellectual Property Department, One PPG Place, Pittsburgh, PA, 15272, US

(21) Appl. No.: 11/448,627

(22) Filed: Jun. 7, 2006

(51) Int. Cl. B05D 1/12; B32B 3/26

(52) U.S. Cl. 428/304.4; 427/180

(57) ABSTRACT

Methods for coating substrates comprising applying a powder to at least a portion of the substrate are disclosed. Following application of the powder layer, the substrate is coated, such as with a base coat and/or clear coat.

### FIELD OF THE INVENTION

The present invention relates to methods for coating substrates comprising applying a powder to at least a portion of the substrate and then coating the substrate.

### BACKGROUND OF THE INVENTION

Numerous substrates are provided with protective and/or decorative coating layers. Typically, the appearance of these coatings is important. Adherence of the coatings to the substrate is also typically important, and can be challenging, especially on substrates such as metals, plastics, and flexible substrates. Many substrates, such as thermoplastic urethane, ethylene vinyl acetate foam, and leather have a significant amount of flexibility. For such substrates, a flexible coating that will give acceptable adherence is particularly desired.

### SUMMARY OF THE INVENTION

The present invention is directed to methods for coating a substrate comprising applying a powder to at least a portion of the substrate, and coating the substrate.

### DETAILED DESCRIPTION OF THE INVENTION

The present invention is directed to methods for coating a substrate comprising applying a powder to at least a portion of the substrate, and then coating the substrate.

Any suitable powder can be used, including organic and/or inorganic powders. Suitable organic powders include, for example, wood flour, wheat flour, wax, cellulosics, baby powder, talcum powder and corn starch. Suitable inorganic powders include, for example, bentone clay, kaolin clay, metallic flakes like Al, Zn and Ni plates, mica, synthetic and naturally occurring sulfonates, carbonates, alumino silicates, titanates, cerium oxide powder, ground limestone, wollastonite (Ca(SiO₃)), and FIBERTEC 9050 (filler/micronite) commercially available from FiberTec, Inc. Any other powder or powder formulation can also be used, including powder coatings commercially available in a number of industries. In certain embodiments, the powder is capable of being fluidized, aerosolized, misted, sprayed or handled via a bulk powder transport means.

In certain embodiments, the powder comprises as a colorant. As used herein, the term “colorant” means any substance that imparts color and/or other opacity and/or other visual effect to the composition. A single colorant or a mixture of two or more colorants can be used. Example colorants include dry pigments such as those used in the paint industry and/or listed in the Dry Color Manufacturers Association (DCMA), and dry special effect compositions. Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example special effect compositions that may be used in the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, borosilicate and bismuth oxychloride based pigments and/or any composition wherein interference results from a refractive index differential within the material and not because of the refractive index differential between the surface of the material and the air.

The powder can have, for example, an average particle size of 0.10 to 100,000 microns, such as 1 to 100,000 microns. The powder can be applied to the substrate by any means known in the art, such as those used for bulk powder transport. Particularly suitable methods include dipping, electrostatic spraying, fluidized bed, and/or misting. It may be desired to remove excess powder, such as agglomerates that form on the surface of the substrate. Removal can be effected by shaking, blowing, tapping and the like.

It will be appreciated that the powder applied according to the present invention does not form a “coating”; that is, the powder is one that does not form a film when heated or, if a standard powder coating is used as the powder, it is not cured. Rather, the powder forms a layer on the substrate according to the present invention. Therefore, the present invention is distinct from methods for coating substrates in which a powder coating or a coating comprising a powder, such as those wherein a powder is added as a filler, rheological control agent, viscosity control agent, and the like, are used to coat a substrate. Similarly, the powders used according to the present methods are not in the form of a putty, which again would contain the powder as an additive or filler and would have a much higher viscosity.

The powder is applied to at least a portion of the substrate. Typically, the powder is applied to those portions of the substrate to which a coating will be subsequently applied.

Any substrate can be treated according to the present invention, including metals, woods, plastics, and the like. In certain embodiments, the substrate is not paper or a printable microporous sheet such as those sold by PPG Industries, Inc. as TESLIN. Particularly suitable substrates include those that are porous, compressible, and/or flexible. A “porous” substrate will be understood as referring to a substrate having pores of any size or sizes. A “compressible” substrate means a substrate capable of undergoing a compressive deformation and returning to substantially the same shape once the compressive deformation has ceased. As used herein, the term “compressive deformation” means a mechanical stress that reduces the volume, at least temporarily, of a substrate in at least one direction. Example compressible substrates include foam substrates, polymeric substrates, polymeric bladders filled with liquid, polymeric bladders filled with air and/or gas, and/or polymeric bladders filled with plasma. As used herein the term “foam substrate” means a polymeric or natural material that comprises an open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe components. Different types of EVA foam can have different types of surface porosity. Molded EVA can comprise a dense surface or “skin”, whereas flat sheets or slabs can exhibit a porous surface. Flexible substrates are also particularly suitable for treatment as described herein. As used herein, the term “flexible substrate” refers to a substrate that can undergo mechanical stresses, such as bending, stretching, compression and the like without significant irreversible change. Examples of flexible substrates include many of the compressible substrates discussed above, and natural leather, synthetic leather, finished natural leather, finished synthetic leather, suede, vinyl, nylon, thermoplastic urethane (TPU), polyurethane, fluid filled bladders, polyolefins and polyolefin blends, polyvinyl acetate and copolymers, polyvinyl chloride and copolymers, urethane elastomers, synthetic textiles, natural textiles, and synthetic and natural rubbers.

As noted above, a powder is applied to at least a portion of the substrate; the substrate is then coated. Any suitable coating can be applied to the substrate. For example, a pigmented and/or unpigmented base coat and/or a clear coat may be applied to the substrate following application of the powder layer. When the powder comprises a colorant, particularly an effect pigment, the coating is typically a clear coat; in this manner, the color and/or effect of the colorant can be seen. In certain embodiments, an effect pigment is used to impart a metallic appearance to the substrate. In certain embodiments, it may be desirable to use a particularly flexible coating. Such coatings are described, for example, in U.S. application Ser. No. 11/155,154, the content of which is hereby incorporated by reference.

The methods according to the present invention result in coated substrates that have good adhesion and/or good appearance. The methods have been observed to control “craters” in coatings and/or to minimize “sag” of coatings. Moreover, adherence is good even when flexible and/or compressible substrates are used.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” powder, “a” coating, and the like, mixtures of such compounds can be used. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

TABLE 1

| | | | | Crosshatch | | |
|---|---|---|---|---|---|---|
| Example | Powder | Basecoat⁴ | Clearcoat⁵ | Adhesion⁶ | Flexability⁷ | Appearance⁸ |
| 1 | — | SPU95005 | XPC60067I | 5 | <50K | Visible pores; |
| | | | | | | de-wetting; |
| | | | | | | craters |
| 2 | Bentone¹ | SPU95005 | — | 5 | >100K | Smooth; |
| | | | | | | defect-free |
| | | | | | | surface |
| 3 | Bentone | SPU95005 | XPC60067I | 5 | >100K | Smooth; |
| | | | | | | defect-free |
| | | | | | | surface |
| 4 | Bentone | XPM61414 | XPC60067I | 5 | >100K | Smooth; |
| | | | | | | defect-free |
| | | | | | | surface |
| 5 | Flour² | XPM61414 | XPC60067I | 5 | >100K | Smooth; |
| | | | | | | defect-free |
| | | | | | | surface |
| 6 | Effect | — | XPC60067I | 5 | >100K | Smooth; |
| | pigment³ | | | | | defect-free |
| | | | | | | surface |
| 7 | Bentone | XPM61414 | XPC60067I | 5 | <10K | Visible pores; |
| | added to | | | | | de-wetting; |
| | liquid | | | | | craters |
| | primer | | | | | |

¹Bentone SD-1, from Elementis Specialties
²GOLD MEDAL All-Purpose flour
³FLAMBOYANCE DX45 blue pigment from PPG Industries, Inc.
⁴VIVAFLEX, a basecoat commercially available from PPG Industries, Inc.
⁵VIVAFLEX, a clearcoat commercially available from PPG Industries, Inc.
⁶ASTM Standard D3359 (Scale 1–5, with 1 being total loss of adhesion and 5 being no loss of adhesion)
⁷PPG tester compresses substrate to ½ height at 7 hertz (100–250K cycles)
⁸Visual observation.

Thermoplastic urethane substrates, Examples 2-6, were pretreated with the designated powder by shaking the substrate in a container of the powder. Upon removing the substrate, any excess powder build up was removed from the substrate by shaking it off or blowing it off lightly with an air gun (GUARDAIR WhisperJet 80WJ). Next, Examples 1-5 were base-coated using a DEVILBISS JGA-510 conventional, siphon-feed gun and 80 air cap at 50-60 psi inlet pressure. The coated substrates were allowed to flash for 10 minutes at ambient conditions before applying the clear-coat in the same manner. Finally, the substrates were flashed at ambient conditions for another 10 minutes and cured at 160° F. for 20 minutes.

The coated substrates were tested to determine adhesion according to ASTM Standard D3359. Adhesion was measured on a scale of 1-5, with 1 being total loss of adhesion and 5 being no loss of adhesion.

After 24 hours, the substrates were also tested for flexibility by compressing the substrate to half its size at a rate of 7 hertz for 100-250K cycles. The substrate was visually inspected for cracks at periodic compression intervals and considered flexible if it reached 100K without cracking.

As can be seen in Table 1, the substrates treated according to the present invention had superior flexibility and appearance of the coating layers as compared with the control (Example 1). In addition, the substrate coated according to Example 6 had a sparkly appearance. Example 7 illustrates that the powder added to a liquid primer was essentially ineffective in improving flexibility and appearance.

Whereas particular embodiments of this invention have been described above for purposes of illustration, it will be evident to those skilled in the art that numerous variations of the details of the present invention may be made without departing from the invention as defined in the appended claims.

1. A method for coating a substrate comprising applying a powder to at least a portion of the substrate and then coating the substrate.

2. The method of claim 1, wherein the powder comprises an organic powder.

3. The method of claim 2, wherein the organic powder comprises flour.

4. The method of claim 1, wherein the powder comprises an inorganic powder.

5. The method of claim 4, wherein the inorganic powder comprises bentone.

6. The method of claim 1, wherein the powder comprises a colorant.

7. The method of claim 6, wherein the colorant comprises an effect pigment.

8. The method of claim 7, wherein the effect pigment comprises mica.

9. A substrate coated according to the method of claim 1.

10. The substrate of claim 9, wherein the substrate comprises EVA foam.

11. The substrate of claim 9, wherein the substrate comprises thermoplastic urethane.

12. The substrate of claim 9, wherein the substrate is porous.

13. The substrate of claim 9, wherein the substrate is compressible.

14. The substrate of claim 9, wherein the substrate is flexible.

15. The substrate of claim 9, wherein the substrate does not comprise paper or printable microporous sheet.

16. The method of claim 1, wherein a pigmented base coat and/or clear coat is applied to the substrate.

17. The method of claim 1, wherein the powder comprises an effect pigment, and the coating comprises a clear coat.
